(19) United States
(12) Patent Application Publication
(10) Pub. No.: US 2017/0285983 A1
(43) Pub. Date: Oct. 5, 2017

(54) STORAGE SYSTEM, STORAGE SYSTEM CONTROL METHOD, AND PROGRAM THEREFOR

(71) Applicant: NEC Corporation, Tokyo (JP)

(72) Inventors: Takeshi MATSUBARA, Tokyo (JP); Toshitaka NAKASHIMA, Tokyo (JP); Yuji KANEKO, Tokyo (JP); Kazunori TANOUE, Tokyo (JP); Masaya SUENAGA, Tokyo (JP); Kenichi MIKI, Tokyo (JP); Fumio MAEHATA, Tokyo (JP)

(21) Appl. No.: 15/471,112

(22) Filed: Mar. 28, 2017

(30) Foreign Application Priority Data
Mar. 31, 2016 (JP) 2016-073660

(51) Int. Cl. G06F 3/06

(52) U.S. Cl. CPC G06F 3/0619; G06F 3/065; G06F 3/0665; G06F 3/067; G06F 3/0689

(57) ABSTRACT

In some embodiments, a storage system may include, but is not limited to, a master volume, one or more link volumes, a master data read frequency determination unit, a load state determination unit, a copy target determination unit, a copy destination determination unit, and a copy controller. The copy target determination unit determines copy target data in the data stored in the master volume on the basis of the read frequency when the load state determination unit determines that the master volume is in a high load state. The copy destination determination unit determines at least one of the one or more link volumes as a copy destination link volume of the copy target data on the basis of the load state of each of the one or more link volumes. The copy controller copies the copy target data into the copy destination link volume.

### BACKGROUND OF THE INVENTION

### Field of the Invention

The present invention relates to a storage system, a storage system control method, and a program therefore.

### Description of Related Art

Several technologies for distributing loads in a storage system such as a disk array device have been proposed.

For example, Japanese Unexamined Patent Application, First Publication No. 2005-215715 describes a load distribution method for a file system in a directory tree format. In the load distribution method, a directory containing a section with a high load on a disk device and all information under the directory are moved to another disk, and a movement source directory and a movement destination directory are correlated.

It is necessary to determine whether a portion of a storage system has a high load for load distribution in the storage system. As targets of the determination increase in number, a load of a device performing the determination increases. In addition, when the determination is sequentially performed, it may take time to determine a portion with a high load if there are many determination targets. If it takes time to determine a portion with a high load, resolution of the high load is delayed.

Despite the increase in the targets causes delay for a resolution of a high load, Patent Document 1 does not describe a limitation on the determination targets for whether the targets have a high load.

### SUMMARY OF THE INVENTION

An object of the present invention is to provide a storage system, a storage system control method, and a program therefor, which are capable of solving the problems described above.

According to a first aspect of the present invention, a storage system may include, but is not limited to, a master volume, one or more link volumes, a master data read frequency determination unit, a load state determination unit, a copy target determination unit, a copy destination determination unit, and a copy controller. The master volume stores data shared by a plurality of devices. The one or more link volumes store individual pieces of data for each device. The master data read frequency determination unit determines a read frequency of each piece of data stored in the master volume. The load state determination unit determines a load state of the master volume and a load state of each of the one or more link volumes. The copy target determination unit determines copy target data in the data stored in the master volume on the basis of the read frequency when the load state determination unit determines that the master volume is in a high load state. The copy destination determination unit determines at least one of the one or more link volumes as a copy destination link volume of the copy target data on the basis of the load state of each of the one or more link volumes. The copy controller copies the copy target data into the copy destination link volume.

According to a second aspect of the present invention, a storage system control device may include, but is not limited to, a master data read frequency determination unit, a load state determination unit, a copy target determination unit, a copy destination determination unit, and a copy controller. The master data read frequency determination unit determines a read frequency of each piece of data stored in a master volume. The each piece of data is shared by a plurality of devices. The load state determination unit determines a load state of the master volume and a load state of each of one or more link volumes configured to store individual pieces of data for each device. The copy target determination unit determines copy target data in the data stored in the master volume on the basis of the read frequency when the load state determination unit determines that the master volume is in a high load state. The copy destination determination unit determines at least one of the one or more link volumes as a copy destination link volume of the copy target data on the basis of the load state of each of the one or more link volumes. The copy controller copies the copy target data into the copy destination link volume.

According to a third aspect of the present invention, a storage system control method includes, but is not limited to, the following acts. A read frequency of each piece of data stored in a master volume is determined. The data is shared by a plurality of devices. There is determined a load state of the master volume and a load state of each of one or more link volumes configured to store individual pieces of data for each device. Copy target data is determined from the data stored in the master volume on the basis of the read frequency when the master volume is determined to be in a high load state. At least one of the one or more link volumes is determined as a copy destination link volume of the copy target data on the basis of the load state of each of the one or more link volumes. The copy target data is copied into the copy destination link volume.

According to a fourth aspect of the present invention, a non-transitory computer-readable medium has computer executable instructions. When the instructions are executed by a computer, the instructions cause the computer to perform at least the following acts. A read frequency of each piece of data stored in a master volume is determined. The data is shared by a plurality of devices. There is determined a load state of the master volume and a load state of each of one or more link volumes configured to store individual pieces of data for each device. Copy target data is determined from the data stored in the master volume on the basis of the read frequency when the master volume is determined to be in a high load state. At least one of the one or more link volumes is determined as a copy destination link volume of the copy target data on the basis of the load state of each of the one or more link volumes. The copy target data is copied into the copy destination link volume.

According to the present invention, it is possible to further reduce a load for determining whether to copy data for load distribution in a storage system.

### BRIEF DESCRIPTION OF THE DRAWINGS

FIG. 1 is a schematic configuration diagram which shows a device configuration of a computer system according to a first embodiment of the present invention.

FIG. 2 is a schematic block diagram which shows a functional configuration of a storage system control device according to the first embodiment.

FIG. 3 is an explanatory diagram which shows an example of the data structure of an access frequency table stored in an access frequency table storage unit according to the first embodiment.

FIG. 4 is an explanatory diagram which shows an example of the data structure of a pool busy monitoring table stored in a pool busy monitoring table storage unit according to the first embodiment.

FIG. 5 is an explanatory diagram which shows an example of a reference destination of master data not copied in the first embodiment.

FIG. 6 is an explanatory diagram which shows an example of a reference destination of copied data in the first embodiment.

FIG. 7 is a flowchart which shows an example of a processing procedure of the storage system control device when unit data included in the master data is copied in the first embodiment.

FIG. 8 is a schematic block diagram which shows a functional configuration of a storage system control device according to a second embodiment of the present invention.

FIG. 9 is an explanatory diagram which shows an example of the data structure of a volume data management table stored in a volume data management table storage unit according to the second embodiment.

FIG. 10 is an explanatory diagram which shows an example of a data reference destination when a reference destination of copied data is fixed in the second embodiment.

FIG. 11 is an explanatory diagram which shows an example of a data reference destination when a data access controller determines a read destination of data among reference destination candidate volumes.

FIG. 12 is a flowchart which shows an example of a processing procedure in which the storage system control device according to the second embodiment changes the reference destination of the copied data.

FIG. 13 is a schematic block diagram which shows a functional configuration of a storage system control device according to a third embodiment of the present invention.

FIG. 14 is an explanatory diagram which shows an example of the data structure of a volume data management table stored in a volume data management table storage unit according to the third embodiment.

FIG. 15 is an explanatory diagram which shows an example of deletion of copied data by a deletion controller according to the third embodiment.

FIG. 16 is a flowchart which shows an example of a processing procedure in which the storage system control device according to the third embodiment deletes the copied data.

FIG. 17 is a schematic configuration diagram which shows a minimum configuration of a storage system according to the present invention.

FIG. 18 is a schematic configuration diagram which shows a minimum configuration of the storage system control device according to the present invention.

### DETAILED DESCRIPTION OF THE INVENTION

Hereinafter, embodiments of the present invention will be described, but the following embodiments do not limit the invention according to the scope of claims. In addition, all combinations of features described in the embodiments are not necessarily essential for the invention.

### First Embodiment

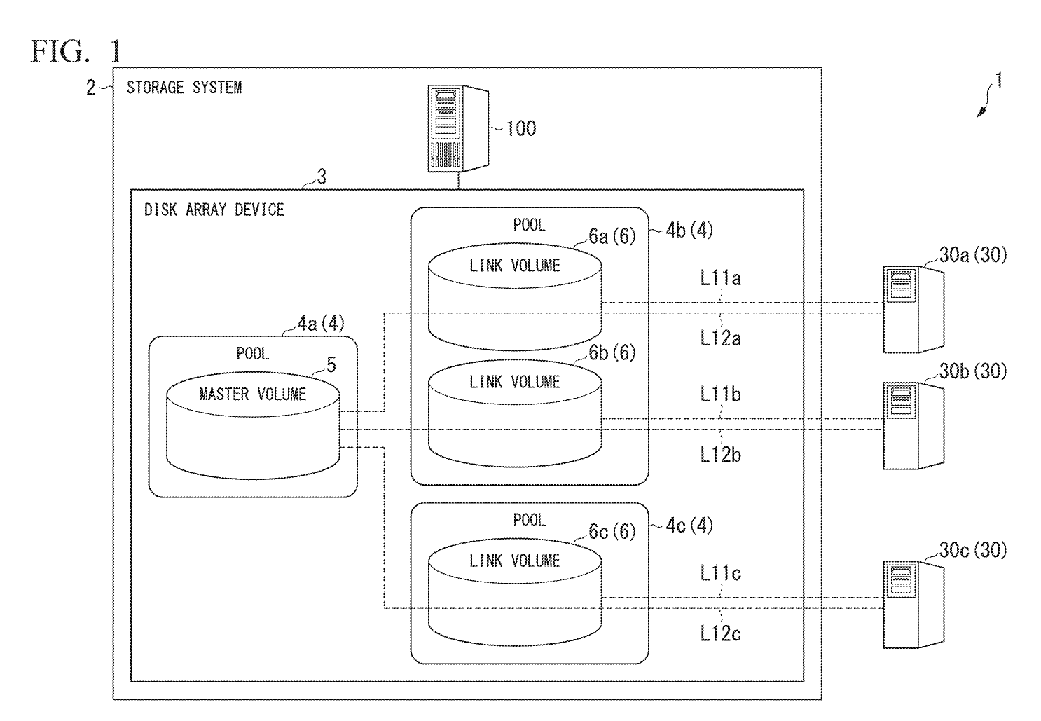

FIG. 1 is a schematic configuration diagram which shows a device configuration of a computer system according to a first embodiment of the present invention. As shown in FIG. 1, a computer system 1 includes a storage system 2 and host computers 30a to 30c. The storage system 2 includes a disk array device 3 and a storage system control device 100. The disk array device 3 includes a master volume 5 and link volumes 6a to 6c.

In the following description, the host computers 30a to 30c are collectively referred to as a host computer 30. Moreover, the link volumes 6a to 6c are collectively referred to as a link volume 6.

In addition, a master volume and a link volume are collectively referred to as a volume.

The storage system 2 functions as an external storage device for the host computer 30.

The disk array device 3 configures a linked clone. Here, the disk array device is a storage device including a plurality of hard disk drives. The linked clone is a storage method for storing data for each client (device that uses data) by combining a common storage region for storing master data common to clients and an individual storage region for storing individual pieces of data for each client. The client herein is a device that uses data stored in the disk array device 3. In an example shown in FIG. 1, each of the host computers 30 corresponds to an example of the client.

However, a device configuring the linked clone is not limited to a disk array device, and may be a storage device which has a storage capacity capable of configuring a linked clone, and has an entire storage region configured from a plurality of storage regions that have different loads.

The master volume 5 stores master data. The master data is data common to the host computers 30a to 30c (that is, data shared by the host computers 30a to 30c). The volume is a management unit of the external storage device. For example, one hard disk drive may configure one volume, but there is no limitation thereto. A plurality of hard disk drives may configure one volume, and one hard disk drive may also configure a plurality of volumes.

Lines L12a to L12c in FIG. 1 indicate that the master volume 5 is a reference destination of the master data of each of the host computers 30.

Each of the link volumes 6 stores individual pieces of data for each of the host computers 30. Specifically, the link volume 6a stores difference data obtained by subtracting the master data from data provided to the host computer 30a by the disk array device 3. In the same manner, the link volume 6b stores difference data obtained by subtracting the master data from data provided to the host computer 30b by the disk array device 3. The link volume 6c stores difference data obtained by subtracting the master data from data provided to the host computer 30c by the disk array device 3. In the following description, difference data obtained by subtracting the master data from data provided to the host computer 30 by the disk array device 3 is simply referred to as difference data.

A line L11a in FIG. 1 shows that the link volume 6a is a reference destination of the difference data of the host computer 30a. In the same manner, a line L11b shows that the link volume 6b is a reference destination of the difference data of the host computer 30b. A line L11c shows that the link volume 6c is a reference destination of the difference data of the host computer 30c.

As described above, each of the host computers 30 accesses the master volume 5 when the master data is referred to. On the other hand, the host computers 30a to 30c access the link volumes 6a to 6c, respectively, when the difference data is referred to. As a result, the disk array device 3 configures the linked clone.

The master volume 5 is included in a pool 4a. The link volumes 6a and 6b are included in a pool 4b. The link volume 6c is included in a pool 4c. In the following description, the pools 4a to 4c are collectively referred to as a pool 4.

The pool is a storage region configured by one or more volumes included in the disk array device 3. For example, each of the pools 4 may be a storage region which is configured as redundant arrays of inexpensive disks or redundant arrays of independent disks (RAID) by bundling one or more physical disks included in the disk array device 3, but it is not limited thereto.

In the following description, a case will be described as an example in which a unit for which a load in the disk array device 3 is measured by the pool 4 as a unit; however, the present invention is not limited thereto, and any case with different loads among the volumes included in the disk array device 3 may be used. For example, the unit for which a load is measured may be a volume. That is, a load may be measurable for each volume.

The host computers 30 are devices that use data stored in the disk array device 3. As described above, each of the host computers 30 accesses the master volume 5 when the master data is referred to. On the other hand, the host computers 30a to 30c access the link volumes 6a to 6c, respectively, when the difference data is referred to.

Each of the host computers 30 is configured by using, for example, a computer.

The storage system control device 100 controls the disk array device 3. The storage system control device 100 may be configured as a portion of the disk array device 3, and may be also configured as a device separate from the disk array device 3. In the following description, a case will be described as an example in which the storage system control device 100 is configured as a device separate from the disk array device 3.

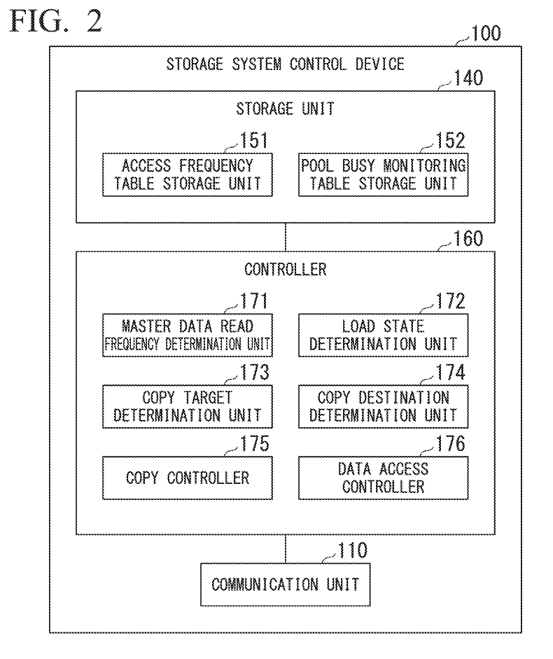

FIG. 2 is a schematic block diagram which shows a functional configuration of the storage system control device 100. As shown in FIG. 2, the storage system control device 100 includes a communication unit 110, a storage unit 140, and a controller 160. The storage unit 140 includes an access frequency table storage unit 151 and a pool busy monitoring table storage unit 152. The controller 160 includes a master data read frequency determination unit 171, a load state determination unit 172, a copy target determination unit 173, a copy destination determination unit 174, a copy controller 175, and a data access controller 176.

The communication unit 110 performs communication with other devices. The communication unit 110 communicates with the disk array device 3 and receives information which indicates a state of the disk array device 3. In addition, the communication unit 110 transmits a control signal to the disk array device 3. When the storage system control device 100 is configured as a portion of the disk array device 3, the communication unit 110 is configured as an interface for exchanging signals with each of the hard disk drives included in the disk array device 3.

The storage unit 140 stores various types of data. The storage unit 140 may be configured using a storage device embedded in the storage system control device 100 and may be also configured using an external storage device of the storage system control device 100. Alternatively, the storage unit 140 may be configured by combining a storage device embedded in the storage system control device 100 and an external storage device of the storage system control device 100.

The access frequency table storage unit 151 stores an access frequency table. The access frequency table is data which indicates an access frequency for each piece of data stored in the master volume 5. Here, data stored in each volume is handled in a certain type of unit, such as in each certain storage capacity or in each file. For each unit, the master data read frequency determination unit 171 measures a data access frequency in the master volume 5, and generates and updates an access frequency table. In the following description, data for each unit is also simply referred to as data. In addition, when it is necessary to specify that the data is data for each unit, the data is also referred to as a unit data.

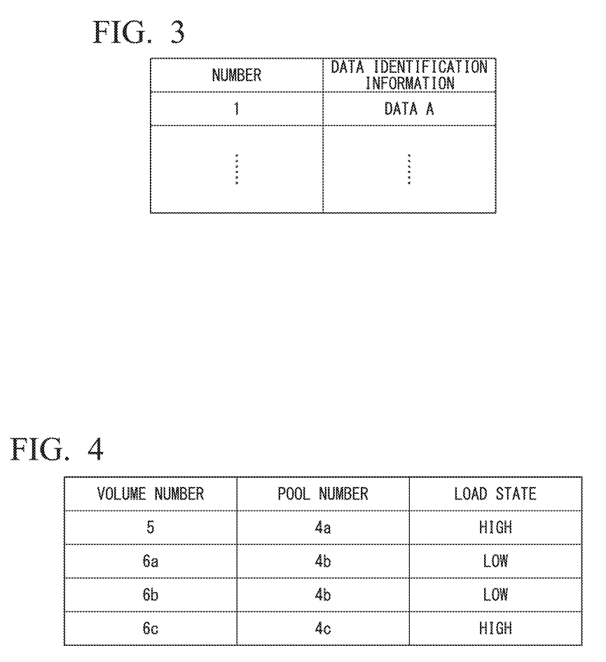

FIG. 3 is an explanatory diagram which shows an example of a data structure of the access frequency table stored in the access frequency table storage unit 151. In an example shown in FIG. 3, the access frequency table is configured as data in a table format. One number and one piece of data identification information are correlated with each other in each row of the access frequency table.

“Data identification information” in the access frequency table is an identification information given to the data stored in the master volume 5 for each unit described above. Accordingly, the data identification information is given to each piece of unit data.

“Number” in the access frequency table is a serial number which shows a descending order of the access frequency for each piece of unit data. In an example shown in FIG. 3, data A has the highest access frequency in the unit data stored in the master volume 5.

The data stored in the access frequency table storage unit 151 is not limited to data in a table format, and may be any data which indicates the access frequency for each piece of unit data.

The pool busy monitoring table storage unit 152 stores a pool busy monitoring table. The pool busy monitoring table is data which shows whether each of the pools 4 is busy. “Busy” herein is a state in which an amount of access to the pool 4 reaches an upper limit of an access capacity of the pool 4 and a wait and a delay occur in accessing the data stored in the pool 4. The load state determination unit 172 acquires load information on each of the pools 4, determines whether each of the pools 4 is in a busy state, and generates and updates the pool busy monitoring table.

“Busy” herein is not limited to an example of a high load. For example, the load state determination unit 172 may monitor whether a load of the pool 4 is equal to or higher than a predetermined load, instead of determining whether the pool 4 is busy.

FIG. 4 is an explanatory diagram which shows an example of the data structure of the pool busy monitoring table stored in the pool busy monitoring table storage unit 152. In an example shown in FIG. 4, the pool busy monitoring table is configured as table format data. One volume number, one pool number, and one load state are correlated with each other in each row of the pool busy monitoring table.

“Volume number” in the pool busy monitoring table is identification information given to each volume. In an example shown in FIG. 4, a volume number “5” indicates a master volume 5. In addition, volume numbers “6a”, “6b”, and “6c” indicate link volumes 6a, 6b, and 6c, respectively.

“Pool number” in the pool busy monitoring table is identification information given to each of the pools 4. In an example shown in FIG. 4, pool numbers “4a”, “4b”, and “4c” indicate pools 4a, 4b, and 4c, respectively. The pool number in the pool busy monitoring table indicates the pool 4 which includes a volume indicated by the associated volume number. In an example shown in FIG. 4, since the master volume 5 is included in the pool 4a, the volume number “5” and the pool number “4a” are correlated with each other. In addition, since both the link volumes 6a and 6b are included in the pool 4b, each of the volume numbers “6a” and “6b” is correlated with the pool number “4b”. Moreover, since the link volume 6c is included in the pool 4c, the volume number “6c” and the pool number “4c” are correlated with each other.

“Load state” in the pool busy monitoring table is data which indicate a load state of each of the pools 4. A value of the load state, “high”, indicates that a correlated pool 4 is in the busy state (accordingly, in a high load state). Also, a value of the load state, “low”, indicates that a correlated pool 4 is not in the busy state (accordingly, in a relatively low load state).

The controller 160 controls each unit of the storage system control device 100 and executes various types of processing. The controller 160 is realized, for example, by a central processing unit (CPU) included in the storage system control device 100 reading a program from the storage unit 140 and executing it.

The master data read frequency determination unit 171 determines a read frequency for each piece of data (unit data) stored in the master volume 5.

The load state determination unit 172 determines a load state of the master volume 5 and a load state of each of the link volumes 6. Specifically, the load state determination unit 172 acquires information which indicates a load of each of the pools 4, and determines whether each of the pools 4 is in the busy state. As described above, the load state determination unit 172 generates and updates the pool busy monitoring table.

The copy target determination unit 173 determines copy target data in the data stored in the master volume 5 on the basis of a read frequency when the load state determination unit 172 determines that the master volume 5 is in the busy state. The copy target data herein is data (unit data) to be copied from the master volume 5 to one or more link volumes 6. The copy target determination unit 173 determines that, for example, unit data with the highest read frequency in the master data is the copy target data. Alternatively, the copy target determination unit 173 may determine that a plurality of pieces of unit data are the copy target data, such as determining that unit data with a predetermined read frequency or more is the copy target data.

The storage system 2 performs load distribution by copying the copy target data. Specifically, each of the host computers 30 reduces a load of the master volume 5 by causing the link volume 6 to read access data read accessed by the master volume 5. That is, since each of the host computers 30 accesses the copy target data stored in the link volume 6 instead of the data stored in the master volume 5, a load of the master volume 5 is reduced.

The copy destination determination unit 174 determines a copy destination link volume 6 for the copy target data determined by the copy target determination unit 173 on the basis of a load of each of the link volumes 6. Specifically, the copy destination determination unit 174 refers to the pool busy monitoring table and determines as a copy destination of the copy target data one of link volumes 6 belonging to a pool not busy.

The copy destination determination unit 174 may determine two or more link volumes 6 as the copy destination for the copy target data. For example, the copy destination determination unit 174 may determine all the link volumes 6 which are not busy to be a copy destination link volume 6.

The copy controller 175 copies the copy target data, which is determined by the copy target determination unit 173, into the copy destination link volumes 6, which are determined by the copy destination determination unit 174. In the following, copy target data which is copied is referred to as copied data.

The data access controller 176 controls an access to the storage system control device 100 by the host computer 30. The data access controller 176 determines, as a read destination of data, one of the master volume 5 and the copy destination link volume 6 when the host computer 30 reads copied data from the storage system control device 100. For example, the data access controller 176 determines that a read destination of the copied data is the copy destination link volume 6.

In addition, the data access controller 176 determines that a reference destination of master data which is not copied is the master volume 5. The master data which is not copied herein is unit data which is not copied in the master data.

Moreover, the data access controller 176 determines that a reference destination of individual pieces of data used by the host computer 30 is the link volume 6 determined in correlation with the host computer 30. In a case of an example shown in FIG. 1, the data access controller 176 determines that reference destinations of individual pieces of data used by the host computers 30a, 30b, and 30c are the link volumes 6a, 6b, and 6c, respectively.

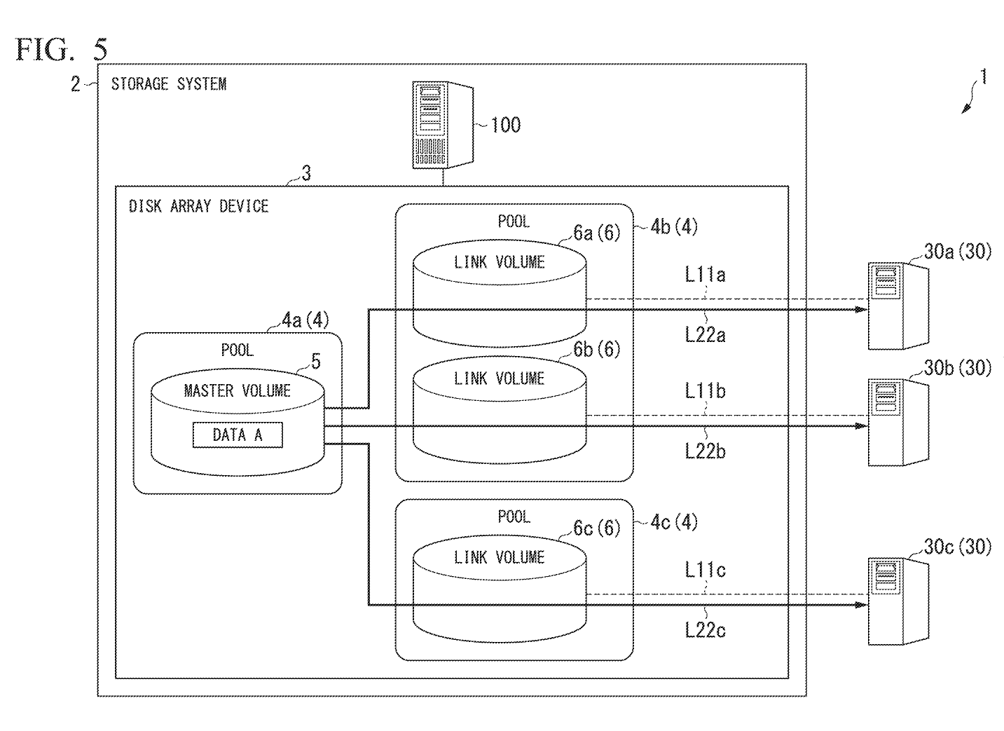

An operation of the storage system control device 100 will be described with reference to FIGS. 5 to 7. FIG. 5 is an explanatory diagram which shows an example of a reference destination of master data which is not copied. FIG. 5 shows a read destination when the host computer 30 reads the master data which is not copied in the device configuration shown in FIG. 1.

Data A in the example shown in FIG. 5 is the master data which is not copied. Lines L22a, L22b, and L22c indicate read destinations when the host computers 30a, 30b, and 30c read the data A, respectively.

When one of the host computers 30a, 30b, and 30c reads the data A, the master volume 5 is accessed. Therefore, when host computers 30 perform reading of the data A at the same time, the load of the master volume 5 increases.

For this reason, the copy controller 175, as described above, copies unit data determined as copy target data by the copy target determination unit 173 in the master data into the copy destination link volume 6 determined by the copy destination determination unit 174.

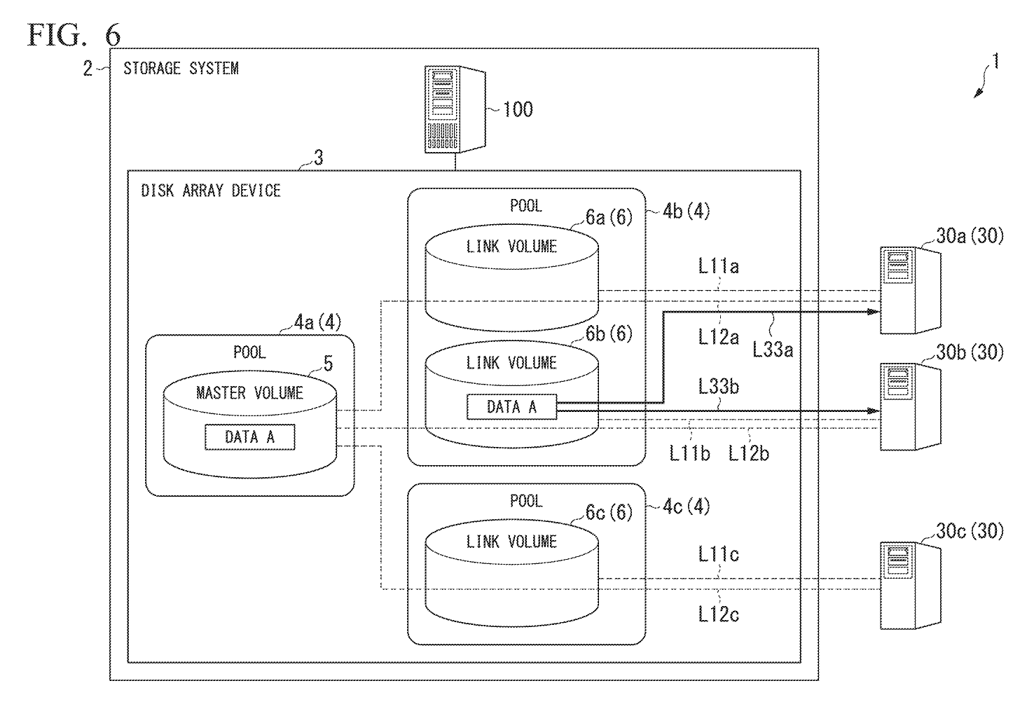

FIG. 6 is an explanatory diagram which shows an example of a reference destination of copied data. FIG. 6 shows an example of a read destination of the data A when the data A is copied into the link volume 6b on a state shown in FIG. 5. Lines L33a and L33b indicate read destinations when the host computers 30a and 30b read the data A, respectively. Both the host computers 30a and 30b read the data A from the link volume 6b.

In the example shown in FIG. 6, when the host computer 30c refers to the data A, the host computer 30c accesses the master volume 5. The data access controller 176 determines, for example, all link volumes 6 belonging to the same pool 4 as a link volume 6 into which data is copied. Then, the data access controller 176 determines, for the host computers 30 correlated with the determined link volumes 6, that read destinations when the host computers 30 read the data are the link volumes 6 into which data is copied.

However, read destinations of data determined by the data access controller 176 are not limited thereto. For example, the data access controller 176 may also determine that the copy destination link volume 6 of the copied data is a read destination even when one of the host computers 30 reads the copied data.

In this manner, it is possible to reduce the load of the master volume 5 by distributing a read destination of a portion of the master data to the link volumes 6.

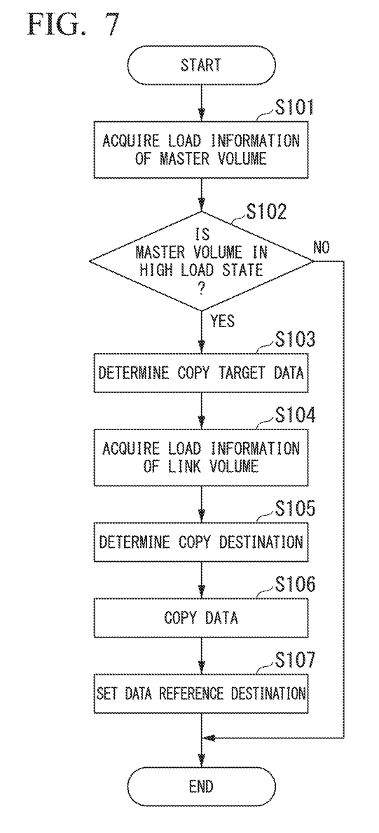

FIG. 7 is a flowchart which shows an example of a processing procedure of the storage system control device 100 when unit data included in the master data is copied. The storage system control device 100, for example, regularly performs processing shown in FIG. 7.

In the processing shown in FIG. 7, the load state determination unit 172 acquires information which indicates a state of the load of the master volume 5 (load information) (step S101). For example, the load state determination unit 172 reads load information of the master volume 5 from the pool busy monitoring table generated and updated by the load state determination unit 172 itself.

Then, the load state determination unit 172 determines whether the master volume 5 is in the high load state (step S102). In the present embodiment, the load state determination unit 172 determines whether the master volume 5 is in the busy state.

If it is determined that the master volume 5 is in the high load state (step S102: YES), the copy target determination unit 173 determines copy target data (step S103). The copy target determination unit 173 refers to an access frequency table and determines, for example, unit data with the highest access frequency as the copy target data on the basis of an access frequency with respect to unit data included in the master data.

The copy destination determination unit 174 acquires load information of each of the link volumes 6 (step S104). The copy destination determination unit 174 reads the load information of each of the link volumes 6 from the pool busy monitoring table.

The copy destination determination unit 174 determines a copy destination of the copy target data on the basis of the load information read in step S104 (step S105). For example, the copy destination determination unit 174 determines a link volume 6 which is the first in a preset order among the link volumes 6 being not busy as a copy destination.

The copy controller 175 copies the copy target data determined by the copy target determination unit 173 into the copy destination link volume 6 determined by the copy destination determination unit 174 (step S106).

The data access controller 176 sets (updates) a reference destination of data (step S107). For example, the data access controller 176 determines all link volumes 6 belonging to the same pool 4 as a link volume 6 into which data is copied. Then, the data access controller 176 determines, for host computers 30 correlated to the determined link volumes 6, that read destinations when the host computers 30 read the data are the link volume 6 into which data is copied.

After step S107, the processing shown in FIG. 7 ends.

In step S102, when it is determined that the master volume 5 is not in the high load state (step S102: NO), the processing shown in FIG. 7 ends. In this case, the storage system control device 100 does not perform copying of the master data. That is, the storage system control device 100 does not copy unit data included in the master data.

As described above, the master volume 5 stores data shared by each of the host computers 30. Each of the link volumes 6 stores individual pieces of data in each of the host computers 30.

In addition, the master data read frequency determination unit 171 determines a read frequency of each piece of the data stored in the master volume 5. The load state determination unit 172 determines a load state of the master volume 5 and a load state of each of the link volumes 6.

Moreover, the copy target determination unit 173 determines copy target data in the data stored in the master volume 5 on the basis of a read frequency when the load state determination unit 172 determines that the master volume 5 is in the high load state. The copy destination determination unit 174 determines a copy destination link volume of the copy target data on the basis of the load state of each of the link volumes 6.

Then, the copy controller 175 copies the copy target data into the copy destination link volume 6.

Accordingly, the storage system control device 100 (load state determination unit 172) may refer to only the load state of the master volume 5 and does not need to refer to a load state of another device to determine whether to copy a portion of the master data. According to the storage system control device 100, it is possible to reduce a load for determining whether to copy data for load distribution in the storage system 2.

When the storage system 2 includes a large number of the link volumes 6, there is no increase in load in which the storage system control device 100 determines whether to copy data for load distribution in the storage system 2.

### Second Embodiment

In a second embodiment, a case will be described as an example in which a storage system control device determines a reference destination of copied data on the basis of a load state of a volume that stores the data.

A device configuration in the second embodiment is the same as described with reference to FIG. 1, and illustration and description are omitted herein. In the second embodiment, the storage system control device 100 shown in FIG. 1 is replaced with a storage system control device 101.

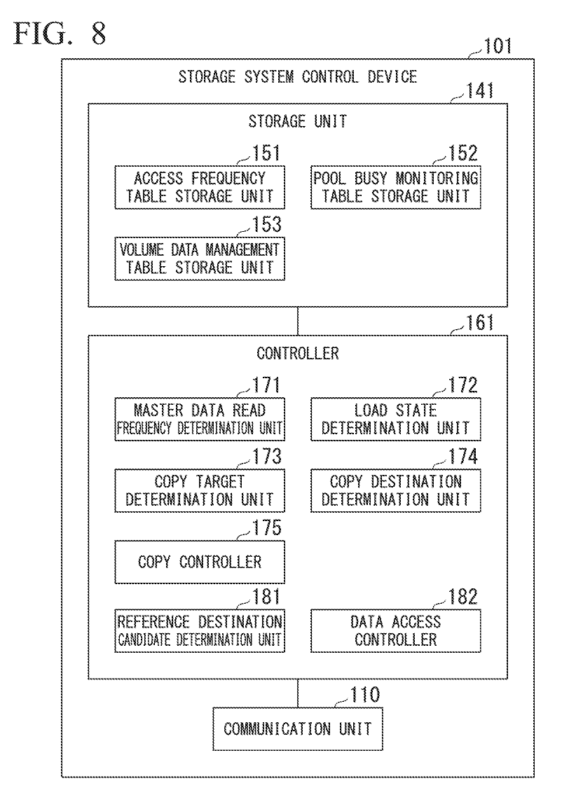

FIG. 8 is a schematic block diagram which shows a functional configuration of the storage system control device 101. As shown in FIG. 8, the storage system control device 101 includes a communication unit 110, a storage unit 141, and a controller 161. The storage unit 141 includes an access frequency table storage unit 151, a pool busy monitoring table storage unit 152, and a volume data management table storage unit 153. The controller 161 includes a master data read frequency determination unit 171, a load state determination unit 172, a copy target determination unit 173, a copy destination determination unit 174, a copy controller 175, a reference destination candidate determination unit 181, and a data access controller 182.

Of the units shown in FIG. 8, units corresponding to respective units shown in FIG. 2 having the same functions will be given the same numerals (151, 152, and 171 to 175) and descriptions thereof will be omitted. In FIG. 8, the storage unit 141 is different from the storage unit 140 shown in FIG. 2 in that the storage unit 141 includes the volume data management table storage unit 153. In addition, the controller 161 is different from the controller 160 shown in FIG. 2 in that the controller 161 includes the reference destination candidate determination unit 181 and has a different operation of the data access controller 182. The other configurations of the storage system control device 101, the storage unit 141, and the controller 161 are the same as the configurations of the storage system control device 100, the storage unit 140, and the controller 160 shown in FIG. 2, respectively.

The volume data management table storage unit 153 stores a volume data management table. The volume data management table is information which indicates copied data stored in each volume. The volume data management table is generated and updated by, for example, the reference destination candidate determination unit 181. When the copy controller 175 copies copy target data, the reference destination candidate determination unit 181 generates and updates the volume data management table so as to reflect a result of the copying in the volume data management table.

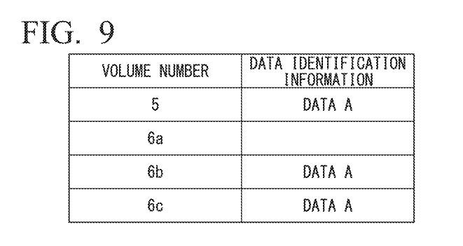

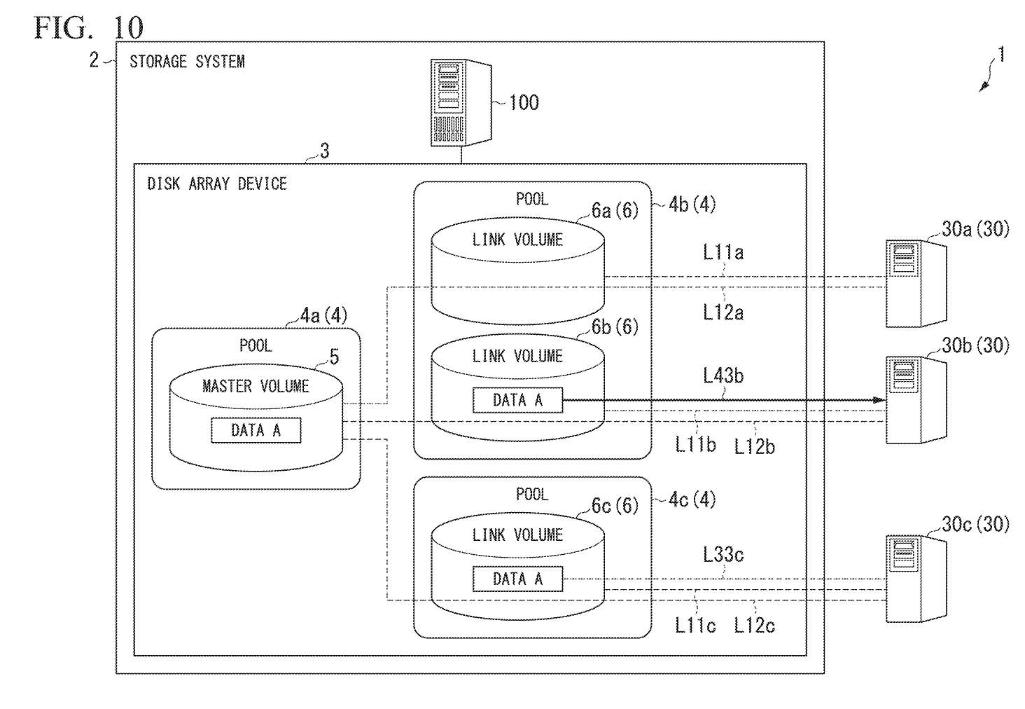

FIG. 9 is an explanatory diagram which shows an example of the data structure of the volume data management table stored in the volume data management table storage unit 153. In the example shown in FIG. 9, the volume data management table is configured as data in a table format. One volume number and zero or more pieces of data identification information are correlated with each other in each row of the volume data management table. That is, a plurality of pieces of data identification information may be correlated with one volume number, and there may be a volume number with which no data identification information is correlated.

“Volume number” of the volume table management table is identification information given to each volume in the same manner as in FIG. 4.

“Data identification information” of the volume data management table is identification information given to each piece of unit data with respect to the copied data stored in the link volume 6.

The volume data management table shows the copied data stored in each volume with the data identification information given to copied data. In the example shown in FIG. 9, all of a master volume 5 and link volumes 6b and 6c store data A, and a link volume 6a does not stored any copied data. When a volume stores a plurality of pieces of copied data, one volume number and a plurality of pieces of data identification information are correlated with each other.

When the load state determination unit 172 determines that a copy destination link volume 6 of the copied data is in the high load state, the reference destination candidate determination unit 181 determines as reference destination change target data the copied data stored in the link volume 6 which is in the high load state. For example, if any one of the link volumes 6 is determined to be in the high load state, the reference destination candidate determination unit 181 refers to the volume data management table and determines the copied data stored in the link volume 6 as reference destination change target data.

The reference destination candidate determination unit 181 determines, as a reference destination candidate volume, a volume storing the same data as the determined reference destination change target data. The reference destination candidate determination unit 181 refers to the volume data management table and determines a volume storing the same data as the reference destination change target data.

The reference destination candidate determination unit 181 determines all volumes storing the same data as the determined reference destination change target data among all volumes included in the storage system 2 (master volume 5 and link volumes 6a to 6c) as reference destination candidate volumes. Alternatively, the reference destination candidate determination unit 181 may exclude the master volume 5 from targets for the reference destination candidate volumes and determine the reference destination candidate volumes from some of the volumes included in the storage system 2.

The data access controller 182 controls an access to the storage system control device 101 by the host computer 30 in the same manner as the data access controller 176 shown in FIG. 2. However, the data access controller 182 is different from the data access controller 176 in that the data access controller 182 determines a read destination among the reference destination candidate volumes when the host computer 30 requests to read the reference destination change target data. In other regards, the data access controller 182 is the same as the data access controller 176.

When the host computer 30 requests to read the reference destination change target data, the data access controller 182 reads load states of the reference destination candidate volumes determined by the reference destination candidate determination unit 181 from the pool busy monitoring table. The data access controller 182 determines one of the reference destination candidate volumes as a read destination volume for the request to read the reference destination change target data on the basis of the read load states. For example, the data access controller 182 determines as the read destination volume a volume which is the first in a preset order among reference destination candidate volumes not being in the busy state.

The data access controller 182 may also determine a volume with the lowest load among the reference destination candidate volumes as the read destination volume. In this case, the pool busy monitoring table may store information which quantitatively shows a level of the load of each volume. The data access controller 182 refers to the pool busy monitoring table and determines the volume with the lowest load among the reference destination candidate volumes.

An operation of the storage system control device 101 will be described with reference to FIGS. 10 to 12.

FIG. 10 is an explanatory diagram which shows an example of a data reference destination when a reference destination of copied data is fixed. FIG. 10 shows an example of a case in which the host computer 30b reads copied data from the link volume 6b in the device configuration shown in FIG. 1.

In an example shown in FIG. 10, the data A is unit data included in the master data, and is copied into each of the link volumes 6b and 6c. The host computer 30b accesses the link volume 6b according to a control of the data access controller 182 and reads the data A when reading the data A from the storage system 2. A line L43b in FIG. 10 indicates a read destination when the host computer 30b reads the data A.

When a load of a data read destination volume is low (not busy in the present embodiment), the data access controller 182 fixes a data read destination. In an example shown in FIG. 10, the data access controller 182 fixes the read destination at which the host computer 30b reads the data to be the link volume 6b. In this case, the data access controller 182 does not need to determine a read destination even when there is a request to read data, and thus a load of the data access controller 182 is relatively low. In addition, the host computer 30 which is a data request source does not need to wait until the data access controller 182 determines a data read destination, and thus the host computer 30 can relatively quickly read data.

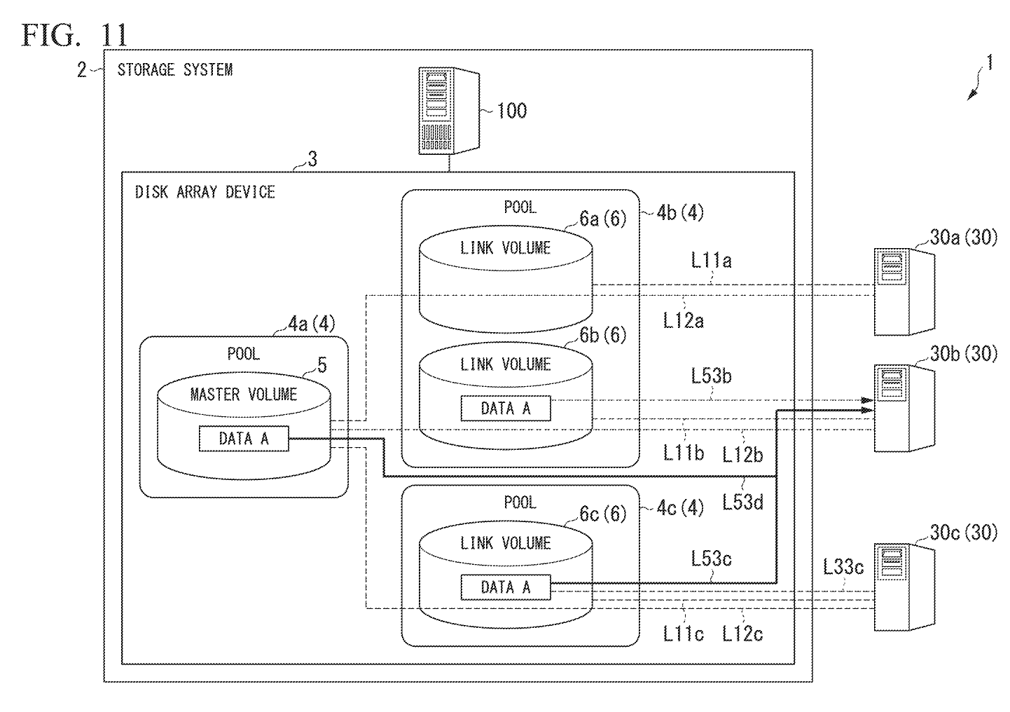

FIG. 11 is an explanatory diagram which shows an example of a data reference destination when the data access controller 176 determines a read destination of data among the reference destination candidate volumes. FIG. 11 shows an example of a case in which the host computer 30b reads the data A from the storage system 2 when the state of the link volume 6b becomes the busy state on the state shown in FIG. 10.

Since the link volume 6b is in the busy state, the data access controller 176 determines, as a read destination of the data A, one of the master volume 5 and the link volume 6c which store the data A like the link volume 6b. A line L53b indicates a read destination of the data A before the link volume 6b is in the busy state. Lines L53c and L53d indicate that read destination candidates at which the host computer 30b reads the data A are the link volume 6c and the master volume 5 in the state shown in FIG. 11. The link volume 6b stores the data A but is in the busy state, and thus the data access controller 176 excludes the link volume 6b from candidates for the read destination of the data A.

In this manner, the data access controller 176 switches reference destinations of the copied data when a load of any volume is high, it is possible to switch a reference destination of the copied data from the volume to another volume. Accordingly, it is possible to reduce the load of the volume with a high load.

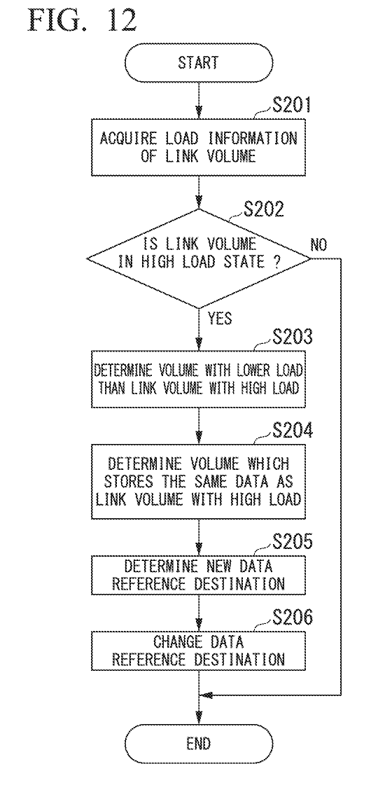

FIG. 12 is a flowchart which shows an example of a processing procedure in which the storage system control device changes the reference destination of the copied data. The storage system control device 101, for example, regularly performs processing shown in FIG. 12.

In the processing shown in FIG. 12, the load state determination unit 172 acquires load information which indicates a load state of each of the link volumes 6 (step S201). The load state determination unit 172 reads load information of each of the link volumes 6 from the pool busy monitoring table.

The load state determination unit 172 determines whether there is a link volume 6 with a high load on the basis of the load information read in step S201 (step S202). In the present embodiment, the load state determination unit 172 determines whether there is a link volume 6 in the busy state.

When the load state determination unit 172 determines that there is no link volume 6 with a high load (step S202: NO), the processing shown in FIG. 12 ends. In this case, the data access controller 182 does not change an access destination of data.

On the other hand, when the load state determination unit 172 determines that there is a link volume 6 with a high load (step S202: YES), the reference destination candidate determination unit 181 determines a volume with a lower load than the link volume 6 with a high load determined by the load state determination unit 172 (step S203). In the present embodiment, the reference destination candidate determination unit 181 determines a volume that is not in the busy state.

The reference destination candidate determination unit 181 determines a volume storing the same copied data as the link volume 6 with a high load determined by the load state determination unit 172 among the volumes determined in step S203 (step S204). The volume determined by the reference destination candidate determination unit 181 in step S204 corresponds to an example of the reference destination candidate volumes. When the link volume 6 determined by the load state determination unit 172 stores a plurality of pieces of copied data, the reference destination candidate determination unit 181 determines a reference destination candidate volume for each piece of the copied data.

The data access controller 182 determines one of the volumes determined in step S204 as a new read destination of the copied data (step S205). As described above, the data access controller 182 determines, for example, a volume which is the first in a preset order as a new read destination volume of the copied data. Alternatively, the data access controller 182 may also determine a volume with the lowest load as a read destination volume.

When the link volume 6 determined by the load state determination unit 172 stores a plurality of pieces of copied data, the data access controller 182 determines a new read destination of the copied data for each piece of the copied data.

The data access controller 182 changes a data read destination for a data read request from the host computer 30 in advance on the basis of the determination in step S205 (step S206).

After step S206, the processing shown in FIG. 12 ends.

At a timing when the host computer 30 requests to read data, the data access controller 182 may determine a data read destination. In this case, the load state determination unit 172 may also determine reference destination candidates at the timing when the host computer 30 requests to read data. Alternatively, the load state determination unit 172 may determine a reference destination in advance, and the data access controller 182 may determine a data read destination among the reference destination candidates at a timing when the host computer 30 requests to read data.

As described above, when the load state determination unit 172 determines that a copy destination link volume 6 storing the copied data is in the high load state, the reference destination candidate determination unit 181 determines reference destination candidate volumes storing the same data as the reference destination change target data from the master volume 5 and the link volumes 6. The reference destination change target data is the copied data, which is copied by the copy controller 175, stored in the link volume 6 in the high load state.

The data access controller 182 determines, as a read destination volume for a read request of the reference destination change target data, one of the reference destination candidate volumes on the basis of a load of each of the reference destination candidate volumes.

Accordingly, when a load of any one of the link volumes 6 increase, the storage system control device 102 determines a new read destination excluded the link volume 6 of which the load increases. The storage system control device 102 is able to reduce the load of the link volume 6. In particular, as described in the first embodiment, when the load of a link volume 6 increases by copying a portion of the master data into the link volume 6 and performing load distribution, it is possible to avoid an access delay by reducing the load of the link volume 6.

### Third Embodiment

In a third embodiment, a case will be described as an example in which a storage system control device deletes copied data with a low access frequency

A device configuration in the third embodiment is the same as described with reference to FIG. 1, and illustration and description will be omitted herein. In the third embodiment, the storage system control device 100 shown in FIG. 1 will be replaced with a storage system control device 102.

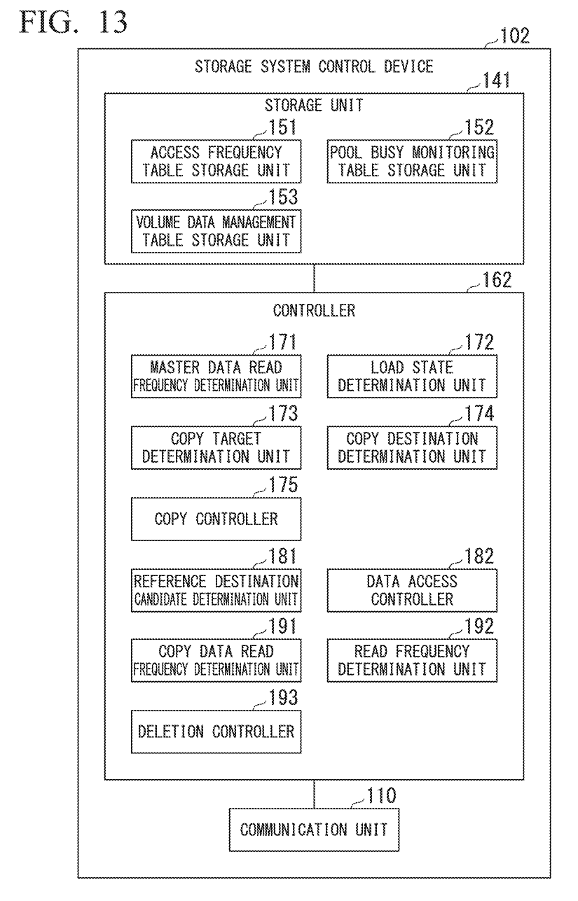

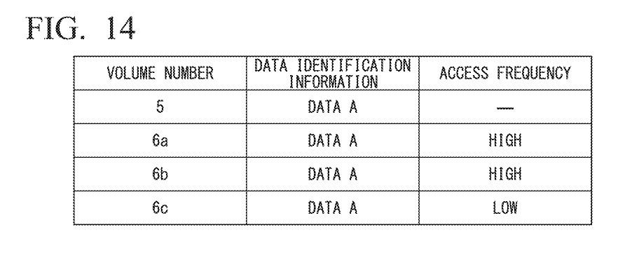

FIG. 13 is a schematic block diagram which shows a functional configuration of the storage system control device 102. As shown in FIG. 13, the storage system control device 102 includes a communication unit 110, a storage unit 141, and a controller 162. The storage unit 141 includes an access frequency table storage unit 151, a pool busy monitoring table storage unit 152, and a volume data management table storage unit 153. The controller 162 includes a master data read frequency determination unit 171, a load state determination unit 172, a copy target determination unit 173, a copy destination determination unit 174, a copy controller 175, a reference destination candidate determination unit 181, a data access controller 182, a copy data read frequency determination unit 191, a read frequency determination unit 192, and a deletion controller 193.

Of the units shown in FIG. 13, units corresponding to respective units shown in FIG. 8 having the same functions will be given the same numerals (141, 151 to 153, 171 to 175, and 181 to 182) and descriptions thereof will be omitted. In FIG. 13, the controller 162 is different from the controller 161 shown in FIG. 8 in that the controller 162 includes the copy data read frequency determination unit 191, the read frequency determination unit 192, and the deletion controller 193. In addition, the storage system control device 102 is different from the storage system control device 101 in that access frequency information is included in a volume data table as described below. The other configurations of the storage system control device 102 and the controller 162 are the same as the configurations of the storage system control device 101 and the controller 161 shown in FIG. 8, respectively.

The function of the storage system control device 102 described in the second embodiment is not indispensable. For example, the storage system control device 102 may include the data access controller 176 instead of the data access controller 182 without including the reference destination candidate determination unit 181.

In the storage system control device 102, the volume data management table storage unit 153 stores a volume data table including access frequency information. The read frequency determination unit 192 writes the access frequency information in the volume data management table.

FIG. 14 is an explanatory diagram which shows an example of the data structure of the volume data management table stored in the volume data management table storage unit 153. In the example shown in FIG. 14, the volume data management table is configured as data in a table format. One volume number, one or more pieces of data identification information, and access frequency information on each piece of the data identification information are correlated with each other in each row of the volume data management table.

“Volume number” and “data identification information” of the volume data management table are the same as in FIG. 9.

“Access frequency” of the volume data management table shows whether an access frequency for copied data indicated by the data identification information is high for each of the link volumes 6. When one link volume 6 stores a plurality of pieces of copied data, the read frequency determination unit 192 writes an access frequency for each of the link volumes 6 and for each piece of the copied data in the volume data management table. The read frequency determination unit 192 writes data identification information on copied data and an access frequency for the copied data in the volume data management table in a one-to-one correlation.

The master volume 5 is not subject to data deletion by the deletion controller 193, and an access frequency for the copied data stored in the master volume 5 is not shown in the volume data management table.

The copy data read frequency determination unit 191 determines a read frequency of the copied data (copy target data copied into the link volumes 6) for each of the link volumes 6 and for each piece of the copied data.

The read frequency determination unit 192 determines whether a read frequency of the copied data determined by the copy data read frequency determination unit 191 is low for each of the link volumes 6 and for each piece of the copied data. That is, the read frequency determination unit 192 determines whether each of the read frequencies determined by the copy data read frequency determination unit 191 is low. For example, the read frequency determination unit 192 compares, with a predetermined threshold value, the read frequency determined by the copy data read frequency determination unit 191 for each of the link volumes 6 and for each piece of the copied data, and determines a low read frequency (the read frequency is low) when the read frequency is lower than the predetermined threshold value.

The deletion controller 193 deletes copied data determined to have a low read frequency by the read frequency determination unit 192. The read frequency determination unit 192 determines whether a read frequency is low for each of the link volumes 6 and for each piece of the copied data. The deletion controller 193 deletes copied data determined to have a low read frequency by the read frequency determination unit 192 from a link volume 6 determined to have a low read frequency.

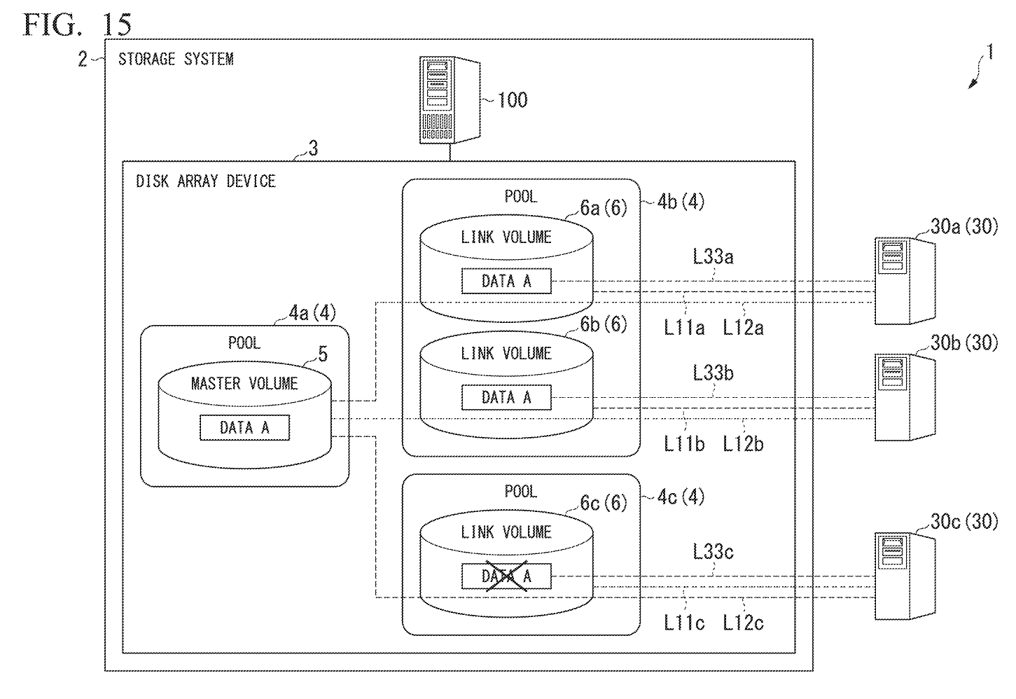

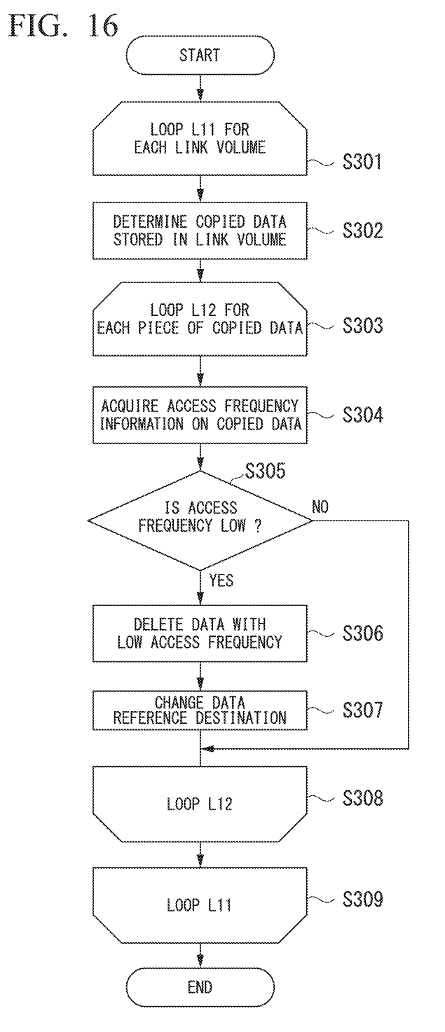

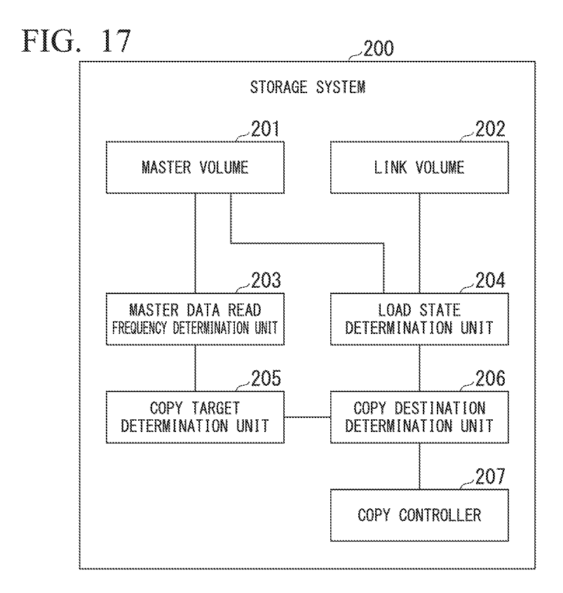

An operation of the storage system control device 102 will be described with reference to FIGS. 15 and 16.

FIG. 15 is an explanatory diagram which shows an example of deletion of copied data by the deletion controller 193. FIG. 15 shows an example of a case in which the master volume 5 and all of the link volumes 6a to 6c store data A and an access frequency of the data A in the link volume 6c is low as shown in FIG. 14 in the device configuration shown in FIG. 1. The data A herein corresponds to an example of the copied data.

Since the access frequency of the data A in the link volume 6c is low, the deletion controller 193 deletes the data A from the link volume 6. An “x” mark in FIG. 15 indicates the deletion of the data A from the link volume 6 by the deletion controller 193.

FIG. 16 is a flowchart which shows an example of a processing procedure in which the storage system control device 102 deletes the copied data. The storage system control device 102, for example, regularly performs processing shown in FIG. 16 for each of the link volumes 6 and for each piece of the copied data stored in the link volume 6.

In the processing shown in FIG. 16, the controller 162 starts a loop L11 for performing processing on each of the link volumes 6 (step S301). In the following, a link volume 6 which is a target to be processed by the loop L11 is referred to as a target link volume.

The master data read frequency determination unit 171 determines and stores copied data stored in the target link volume (step S302). For example, the master data read frequency determination unit 171 refers to the volume data management table and reads all pieces of the data identification information in association with the target link volume.

The controller 162 starts a loop L12 for performing processing on each piece of the copied data determined by the master data read frequency determination unit 171 in step S302 (step S303). In the following, the copied data which is a target to be processed by the loop L12 is referred to as target data.

The read frequency determination unit 192 acquires access frequency information of the target data (step S304). Specifically, the read frequency determination unit 192 reads access frequency information indicating whether an access frequency for the target data of the target link volume is high or low from the volume data management table. The read frequency determination unit 192 determines whether an access frequency for the target data of the target link volume is low (step S305). Specifically, the read frequency determination unit 192 determines whether the access frequency information read in step S304 indicates a low access frequency.

When it is determined that the access frequency information indicates a low access frequency (step S305: YES), the deletion controller 193 deletes data with a low access frequency (step S306). That is, the deletion controller 193 deletes the target data from the target link volume.

The data access controller 182 changes a reference destination of the data deleted by the deletion controller 193 in step S306 (step S307). For example, the data access controller 182 determines the master volume 5 as a reference destination of the data.

The controller 162 performs termination processing of the loop L12 (step S308). Specifically, the controller 162 determines whether processing of the loop L12 with respect to all of the copied data obtained in step S302 is completed. When the controller 162 determines that the processing is completed, the controller 162 ends the loop L12. On the other hand, when the controller 162 determines that there is copied data not processed, the controller 162 returns to step S303 to continue the processing of the loop L12 with respect to the unprocessed copied data.

In step S308, when the controller 162 ends the loop L12, the controller 162 performs termination processing of the loop L11 (step S309). Specifically, the controller 162 determines whether processing of the loop L11 with respect to all of the link volumes 6 is completed. When the controller 162 determines that the processing is completed, the controller 162 ends the loop L11. On the other hand, when the controller 162 determines that there is a link volume 6 not processed, the controller 162 returns to step S301 to continue the processing of the loop L11 with respect to the unprocessed link volume 6.

In step S309, when the loop L11 ends, the controller 162 ends the processing shown in FIG. 16.

In step S305, when the controller 162 determines that an access frequency is not low (step S305: NO), the controller 162 proceeds to step S308.

As described above, the copy data read frequency determination unit 191 determines a read frequency of the copied data for each of the link volumes 6 and for each piece of the copied data. Then, the read frequency determination unit 192 determines whether the read frequency of the copied data is low for each of the link volumes 6 and for each piece of the copied data. The deletion controller 193 deletes copied data determined to have a low read frequency by the read frequency determination unit 192 from a corresponding link volume 6.

Accordingly, the storage system control device 102 deletes the copied data with a low access frequency. Thus, it is possible to suppress expansion of capacity of the link volume 6.

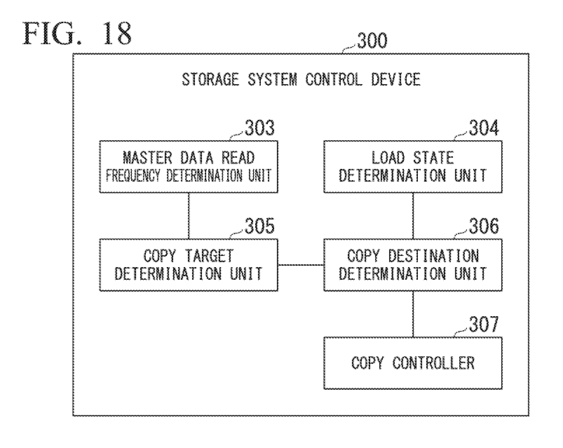

A minimum configuration of the present invention will be described with reference to FIGS. 17 and 18.

FIG. 17 is a schematic configuration diagram which shows a minimum configuration of the storage system according to the present invention. A storage system 200 shown in FIG. 17 includes a master volume 201, a link volume 202, a master data read frequency determination unit 203, a load state determination unit 204, a copy target determination unit 205, a copy destination determination unit 206, and a copy controller 207.

In such a configuration, the master volume 201 stores data shared by a plurality of devices using data. The link volume 202 stores individual pieces of data in each of the devices using data. The master data read frequency determination unit 203 determines a read frequency of each piece of the data stored in the master volume 201. The load state determination unit 204 determines a load state of the master volume 201 and a load state of the link volume 202.

The copy target determination unit 205 determines copy target data in the data stored in the master volume 201 based on a read frequency when the load state determination unit 204 determines that the master volume 201 is in the high load state. The copy destination determination unit 206 determines a copy destination link volume 202 of the copy target data based on the load state of the link volume 202. The copy controller 207 copies the copy target data into the copy destination link volume 202.

Accordingly, the storage system 200 refers to only the load state of the master volume 201 and does not need to refer to a load state of another device to determine whether to copy a portion of the master data. The storage system 200 is able to reduce a load for determining whether to copy data for load distribution in the storage system 200 itself.

FIG. 18 is a schematic configuration diagram which shows a minimum configuration of the storage system control device according to the present invention. A storage system control device 300 shown in FIG. 18 includes a master data read frequency determination unit 303, a load state determination unit 304, a copy target determination unit 305, a copy destination determination unit 306, and a copy controller 307.

In such a configuration, the master data read frequency determination unit 303 determines a read frequency of each piece of the data stored in the master volume storing data shared by a plurality of devices using data. The load state determination unit 304 determines a load state of the master volume and a load state of each of one or more link volumes storing individual pieces of data for each of the devices using data.

The copy target determination unit 305 determines copy target data in the data stored in the master volume on the basis of the read frequency when the load state determination unit 304 determines that the master volume is in the high load state. The copy destination determination unit 306 determines a copy destination link volume of the copy target data on the basis of a load state of each of the link volumes. The copy controller 307 copies the copy target data into the copy destination link volume.

Accordingly, the storage system control device 300 refers to only the load state of the master volume and does not need to refer to a load state of another device to determine whether to copy a portion of the master data. The storage system control device 300 is able to reduce a load of determining whether to copy data for load distribution in a storage system.

A program for realizing all or a portion of the functions of the controllers 160, 161, and 162, the master data read frequency determination units 203 and 303, the load state determination units 204 and 304, the copy target determination units 205 and 305, the copy destination determination unit 206 and 306, and the copy controllers 207 and 307 is recorded in a computer readable recording medium, and the program recorded in the recording medium is read by a computer system and executed, and thereby processing of each unit may be performed. “Computer system” herein is defined to include hardware such as an OS or peripheral equipment.

In addition, “computer-readable recording medium” refers to a storage device such as a flexible disk, a magneto-optical disk, a portable medium such as a ROM or a CD-ROM, and a hard disk embedded in a computer system. Moreover, the program may realize a portion of the functions described above, and may further realize the functions described above in combination with a program recorded in advance in the computer system.

As described above, the embodiments of the present invention have been described in detail with reference to the drawings, but a specific configuration is not limited to the embodiments and also includes a design and the like within a scope not departing from the gist of the present invention.

Priority is claimed on Japanese Patent Application No. 2016-073660, filed Mar. 31, 2016, the content of which is incorporated herein by reference.

What is claimed is:

1. A storage system comprising:
a master volume configured to store data shared by a plurality of devices;
one or more link volumes configured to store individual pieces of data for each device;
a master data read frequency determination unit configured to determine a read frequency of each piece of the data stored in the master volume;
a load state determination unit configured to determine a load state of the master volume and a load state of each of the one or more link volumes;
a copy target determination unit configured to determine copy target data in the data stored in the master volume on the basis of the read frequency when the load state determination unit determines that the master volume is in a high load state;
a copy destination determination unit configured to determine at least one of the one or more link volumes as a copy destination link volume of the copy target data on the basis of the load state of each of the one or more link volumes; and
a copy controller configured to copy the copy target data into the copy destination link volume.

2. The storage system according to claim 1, further comprising:
a reference destination candidate determination unit configured to determine at least one reference destination candidate volume from the master volume and the one or more link volume when the load state determination unit determines that the copy destination link volume is in the high load state, the at least one reference destination candidate volume storing the same copy target data as the copy destination link volume determined to be in the high load state; and
a data access controller configured to determine, from the at least one reference destination candidate volume, a read destination volume for a read request of the copy target data stored in the copy destination link volume determined to be in the high load state, on the basis of the load of the at least one reference destination candidate volume.

3. The storage system according to claim 1, further comprising:
a copy data read frequency determination unit configured to determine a read frequency of the copy target data for each of the link volumes and for each piece of the copy target data;
a read frequency determination unit configured to determine whether a read frequency of the copy target data is low for each of the link volumes and for each piece of the copy target data; and
a deletion controller configured to delete copy target data determined to have a low read frequency by the read frequency determination unit.

4. A storage system control method comprising:
determining a read frequency of each piece of data stored in a master volume, the data being shared by a plurality of devices;
determining a load state of the master volume and a load state of each of one or more link volumes configured to store individual pieces of data for each device;
determining copy target data from the data stored in the master volume on the basis of the read frequency when the master volume is determined to be in a high load state;
determining at least one of the one or more link volumes as a copy destination link volume of the copy target data on the basis of the load state of each of the one or more link volumes; and
copying the copy target data into the copy destination link volume.

5. A non-transitory computer-readable medium having computer executable instructions, when the instructions are executed by a computer, to cause the computer to perform at least:
determining a read frequency of each piece of data stored in a master volume, the data being shared by a plurality of devices;
determining a load state of the master volume and a load state of each of one or more link volumes configured to store individual pieces of data for each device;
determining copy target data from the data stored in the master volume on the basis of the read frequency when the master volume is determined to be in a high load state;
determining at least one of the one or more link volumes as a copy destination link volume of the copy target data on the basis of the load state of each of the one or more link volumes; and
copying the copy target data into the copy destination link volume.
